(19) United States
(12) Patent Application Publication
(10) Pub. No.: US 2002/0196289 A1
(43) Pub. Date: Dec. 26, 2002

(54) Preview picture output system and method for controling operation of the same

(76) Inventors: Koichi Sakamoto, Asaka-shi (JP); Kazuhiko Takemura, Asaka-shi (JP); Koji Ichikawa, Asaka-shi (JP); Tetsuro Ashida, Asaka-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/176,953

(22) Filed: Jun. 21, 2002

(30) Foreign Application Priority Data
Jun. 22, 2001 (JP) 2001-188986

(51) Int. Cl. G09G 5/00

(52) U.S. Cl. 345/838

(57) ABSTRACT

A preview image output system compares image data and a preview file list that records data such as the date and time when thumbnail images representative of image files are displayed for preview. A determination is made, based on the comparison, which of the images have not been output for preview, and image data representative of the images that is determined not to have been output for preview is read out, and thumbnail images of the images represented by the image data that is determined not to have been output for preview are first displayed for preview.

### BACKGROUND OF THE INVENTION

1. Field of the Invention

The present invention relates to a system for outputting preview images, and a method for controlling am operation of the system. The present invention also relates to a program for outputting preview images and a storage device for storing the program.

2. Description of Related Art

Recording media such as memory cards and semiconductor memories are all shifting towards larger capacity. As a result, image data representing an enormous number of images can be recorded on recording media.

In order to check the contents of images shown through image data recorded on a recording medium, thumbnail images of those images can be displayed in areas prescribed for a plurality of frames (preview display). However, even when preview display is available, it is not easy to search for the desired image when there are an extremely large number of images.

This situation is not limited to preview displays and is also applicable when printing thumbnail images of a plurality of frames on a single sheet of paper.

### SUMMARY OF THE INVENTION

The present invention relates to a technology that provides a preview output that enables the user to efficiently find desired images.

In accordance with an embodiment of the present invention, a preview image output system compares image data and a preview file list that records data such as the date and time when thumbnail images representative of image files are displayed for preview. A determination is made, based on the comparison, which of the images have not been output for preview, and image data representative of the images that is determined not to have been output for preview is read out, and thumbnail images of the images represented by the image data that is determined not to have been output for preview are first displayed for preview.

A preview image output system in accordance with another embodiment of the present invention includes a determination device that determines if any of the images of a plurality of frames representative of image data of images of a plurality of frames recorded on a recording medium has not been output for preview; an input device for inputting a preview output command; a reading device that, in response to an input of a preview output command from the input device, reads from the recording medium image data representing the image determined not to have been output for preview by the determination device; and a preview output device that initial preview output the image represented by the image data read out by the reading device.

In accordance with another embodiment of the present invention, an operation control method used for the preview image output system is provided. In one aspect, the operation control method determines which one (or ones) of images of a plurality of frames representative of image data of images of a plurality of frames recorded on a recording medium has not been output for preview, reads from the recording medium in response to an input of a preview output command image data representing the image determined not to have been output for preview, and outputs the image representative of the data read for initial preview.

In addition, the present invention provides a program to implement the operation control method and a recording medium that stores the program.

According to the present invention, in a system that is capable of outputting images of a plurality of frames in a specified area (display area or paper), at least one image among images of a plurality of frames, which has not been output for preview is determined. When a preview output command is given, image data representing the image that has not been output for preview is read from the recording medium. The image representative of the image data read is output for initial preview; in other words, the image is output first for preview.

Among the images representative of the image data recorded on a recording medium, at least one image that has not been output for preview is the first to be output for preview, which allows a continuation of preview output from the previous occasion. Consequently, an efficient preview output is possible. Accordingly, desired images can be found efficiently.

The preview output device may be, for example, a display device to initially display in the preview display area images representative of image data read by the reading device or a printer that initially prints on preview paper images representative of image data read by the reading device.

The recording medium may include a preview list file that records data representing images that have not been preview output. In this case, the determination device may determine at least an image that has not been output for preview based upon the data recorded in the preview list file.

A reconstructing device to reconstruct the preview list file may be added. The reconstructing device may compare the image data recorded on the recording medium with the data stored in the preview list before the initial preview output through the preview output device. The reconstructing device may make a determination based on the comparison if a reconstruction of the preview list file is necessary, and reconstruct the preview list file if necessary.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a block diagram of an electrical structure of an image reproduction apparatus.

FIG. 2 shows a structure of a preview list file.

FIG. 3 shows a flowchart of a processing procedure employed by an image reproduction apparatus.

FIG. 4 shows a flowchart of a processing procedure employed by an image reproduction apparatus.

FIG. 5 shows one example of preview display images.

### DESCRIPTION OF PREFERRED EMBODIMENTS

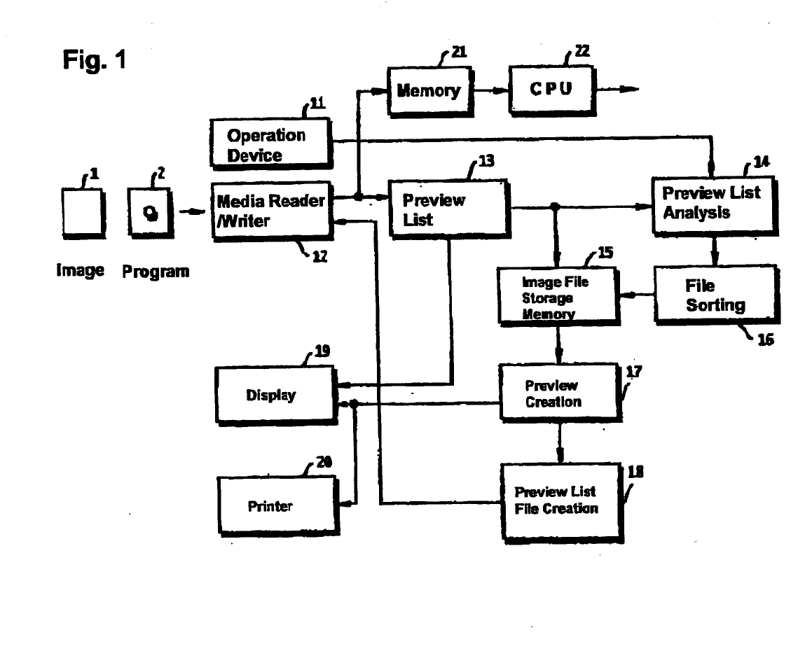

FIG. 1 shows a block diagram of an electrical structure of an image reproduction device in accordance with an embodiment of the present invention.

A CPU 22 controls the overall operation of the image reproduction device.

The image reproduction device according to the present embodiment can display thumbnail images (images) of a plurality of frames in a preview display area and/or index print on a sheet of paper thumbnail images (images) of a plurality of frames.

First, a medium 2 that stores an operation program for the image reproduction device is loaded on a media reader writer 12. The operation program is read from the medium 2 and recorded on a memory 21. The image reproduction device operates in accordance with the operational program recorded on the memory 21.

The medium 2 that stores the operational program is unloaded from the media reader writer 12, and a medium 1 is loaded on the media reader writer 12. The medium 1 stores image data. The medium 1 may also store a preview list file for preview-display and/or index printing to be described below.

If the preview list file is stored in the medium 1, the preview list file is read by the media reader writer 12 and detected by a preview list sensor circuit 13. The detected preview list file is input into a preview list analysis circuit 14. The image reproduction device includes an operation device 11 that is operated by the user. Operation signals from the operation device 11 are provided to the preview list analysis circuit 14.

The thumbnail image data recorded on the medium 1 is read by the media reader writer 12 and temporarily recorded on an image file storage memory 16 via the preview list sensor circuit 13.

In the preview list analysis circuit 14, contents of the preview list read from the medium 2 are analyzed and data representing the result or the analysis are provided to a file sorting circuit 16. In the file sorting circuit 16, the thumbnail images temporarily recorded on the image file 15 are subject to a sorting process 80 that the thumbnail images would be displayed in the order indicated in the preview list. The sorting process will be described in greater detail later.

The thumbnail image data output from tho image file storage memory 15 are input in a preview creating circuit 17. Image data representing preview images are created in the preview creating circuit 17 and provided to a display device 19. Preview images are displayed on the display screen of the display device 19. When preview images are displayed, the preview list is reconstructed in a preview list creating circuit 18. The reconstructed preview list is provided to the media reader writer 12. The medial reader write 12 rewrites, the preview list recorded on the medium 1.

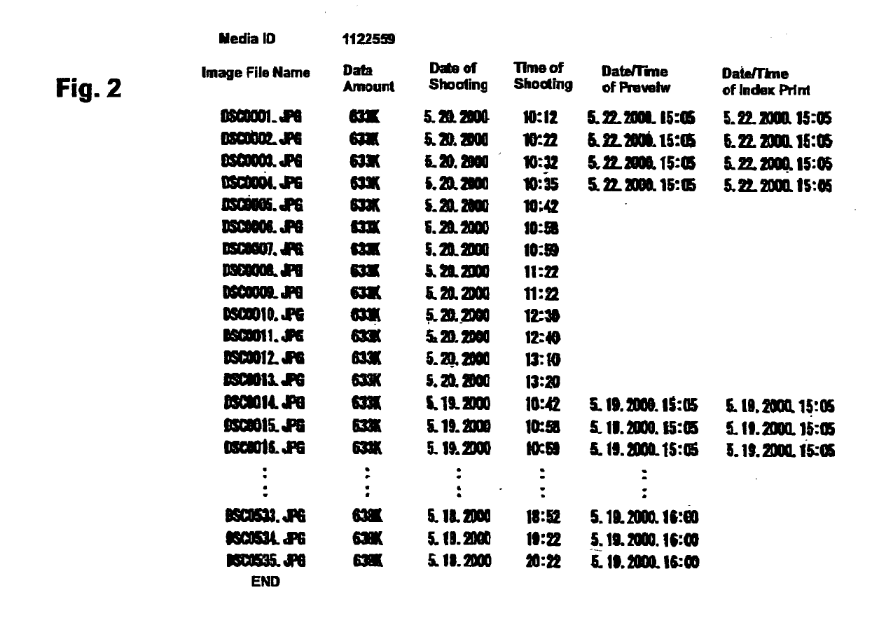

FIG. 2 is an example of a structure of a preview list file recorded on the medium 1.

The preview list stores, in addition to the medium ID to identify the medium 1, the following data: image filenames; data size of each of image files specified by the image filenames; shooting date, shooting time, preview display date and time and the index printing date and time of each image representing the corresponding image file.

The preview display date and time indicate the date and time that a thumbnail image corresponding to an image specified by an image filename was displayed for preview. The index printing date and time indicate the date and time that a thumbnail image corresponding to an image specified by an image filename was index printed.

In the example shown in FIG. 2, the thumbnail images corresponding to images specified by the image Renames “DSC0001.JPG” through “DSC0004.JPG” wore displayed for preview and index printed on May 22, 2000 at 15:05. Also, the thumbnail images corresponding to images specified by the image filenames “DSC0014.JPG” through “DSC0016.JPG” were displayed for preview and index printed on May 19, 2000 at 15:05.

Further, the thumbnail images corresponding to images specified by the image filenames “DSC0005.JPG” through “DSC0013.JPG” were never displayed for preview or index printed. And the thumbnail images corresponding to images specified by the image filenames “DSC0532.JPG” through “DSC0585.JPG” were displayed for preview on May 19, 2000 but were not index printed.

In the present embodiment, a preview display command may be given by an automatic playback, and a determination is made as to whether there are any thumbnail images that have not been displayed for preview. If there are thumbnail images that have not been displayed for preview, one or more thumbnail images that have not been displayed for preview are first displayed for preview. Similarly, when performing an automatic index printing, if there are any thumbnail images that have not been index printed, those thumbnail images that have not been index printed are index printed first.

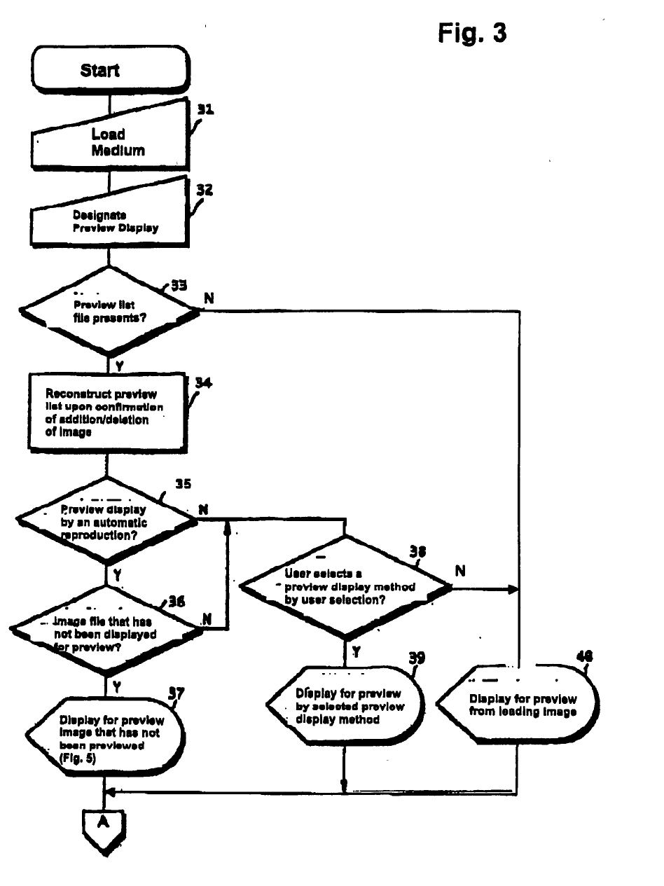

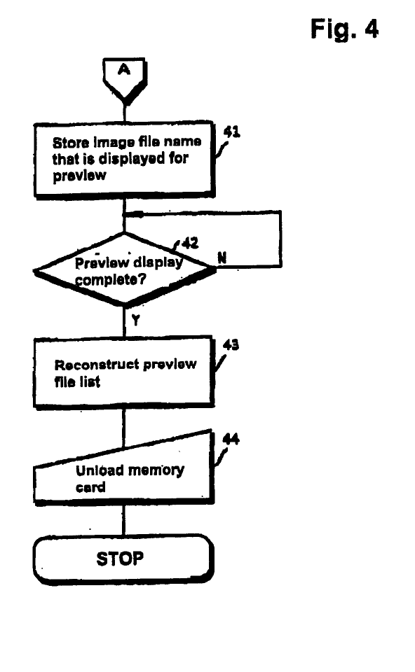

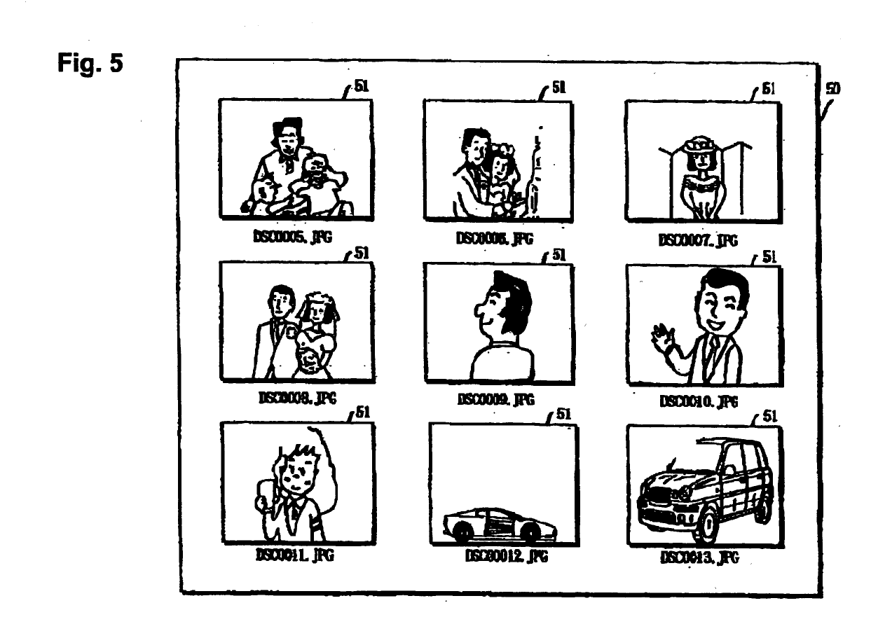

FIGS. 3 and 4 show a flowchart indicating a processing procedure of the image reproduction device. FIG. 5 shows an example of a preview display.

The medium 1 that stores image files and thumbnail image files is loaded on the media reader writer 12 (step 31). The user operates the operation device 11 to designate a preview display (step 32).

If the preview list sensor circuit 13 detects that a preview list file is stored on the medium 1 loaded on the media reader writer 12 (YES at step 33), the detected preview list file is analyzed in the preview list analysis circuit 14. Additionally, the image files stored on the medium 1 are read by the media reader writer 12 and provided to the preview list analysis circuit 14 via the preview list sensor circuit 13.

The preview list analysis circuit 14 detects whether the image filenames stored in the preview list file and the image files actually stored on the medium 1 match with each other. If, as a result of adding new image files to the medium 1 or deleting image files already stored on the medium 1 after the preview list file has been created, there are any discrepancies between the image filenames stored in the preview list file and the image files actually stored on the medium 1, the preview list file is reconstructed in the preview list analysis circuit 14 to make them match with each other (step 84).

If the user has selected a preview display by an automatic playback (YES at step 35), whether there are any image files that have not been displayed for preview yet is checked (step 36). Specifically, whether there are any image filenames whose preview display date and time column is blank in the preview list file is checked.

If there are any image files that have not been displayed for preview (YES at step 37), thumbnail image data corresponding to the image files that have not been displayed for preview are read from the image file storage memory 15 through the control of the file sorting circuit 16. Preview display image data are created in the preview creating circuit 17. When the preview display image data created are provided to the display device 19, a preview image consisting of thumbnail images that have not been displayed for preview is displayed first on the display screen of the display device 19, as shown in FIG. 5 (step 37). In other words, only those thumbnail images that have not been displayed for preview may be initially displayed on the display screen of the display device 19.

Referring to FIG. 5, a preview image 50 has multiple thumbnail image display areas 51. The thumbnail image display areas 51 display thumbnail images that have not yet been displayed for preview. Image filenames corresponding to the various thumbnail images are displayed beneath each thumbnail image.

Data representing image filenames corresponding to the thumbnail images displayed for preview are temporarily recorded in a memory (not shown in the figure) contained in the preview list file creating circuit 18 (step 41).

When the preview display ends (i.e., when the user gives a preview display end command) (YES at step 42), the preview list file is reconstructed in the preview list file creating circuit 18 by checking against the image filenames temporarily recorded in the memory within the preview list file creating circuit 18 (step 43). The reconstructed preview list file is provided to the media reader writer 12 and recorded. Subsequently, the medium 1 is removed from the media reader writer 12 (step 44).

If the user has not selected a preview display through an automatic playback (NO at step 35) or if there are no image files that have not been displayed for preview (NO at step 36), whether a preview display method has been designated through a user selection is checked (step 38).

If the preview display method has been designated (YES at step 38), a preview display takes place based upon the designated preview display method. For example, the preview display method may perform a display designating a date such as the date of the preview display that took place immediately before the last one, or a display of thumbnail images specified by the filename input) (step 39). If the preview display method has not been designated (NO at step 38), or if there are no preview list files on the medium 1 (NO at step 33), the thumbnail images are displayed for preview in the order their corresponding image filenames appear (step 40).

When a preview display through an automatic playback is performed and there are images that have not yet been displayed for preview, the images to be displayed for preview first (i.e., initial preview display) are those images that have not been displayed for preview before. A preview display can start where the last preview ended. For example, when a preview display was interrupted while searching for a desired image, the next preview display can start where the search was interrupted. Desired images can be searched efficiently. This is especially effective when there is an extremely large number of image files.

The embodiment above describes preview display, but index printing in which a plurality of thumbnail images are printed can be processed similarly. When an automatic index printing is selected, thumbnail images that have not been index printed can be printed first.

In the embodiment described above, various circuits are constructed in hardware. However, functions equivalent to the various circuits can be constructed through software.

What is claimed is:

1. A preview image output system comprising:
a determination device that compares image data representative of a plurality of images with a preview list file that records at least data indicating that images have been displayed for preview, and determines if any of the plurality of images in the image data has not been output for preview; and
an output device that first shows at least one image among the plurality of images in the image data that is determined not to have been output for preview.

2. A preview image output system according to claim 1, wherein the preview list file records at least data indicating that thumbnail images representing the images have been displayed for preview, and the output device shows at least one thumbnail image representing a corresponding one of the plurality of images in the image data.

3. A preview image output system according to claim 2, wherein the output device is a display apparatus that initially displays in a preview display region thereof at least one thumbnail image.

4. A preview image output system according to claim 2, wherein the output device is a printer that prints on a preview paper an image representing at least one thumbnail image.

5. A preview image output system according to claim 1, wherein the preview list file stores data indicative of images that have not been output for preview, and the determination device determines the image that has not been output based on the data stored in the preview list file.

6. A preview image output system according to claim 1, further comprising a reconstructing device that compares the image data with the data stored in the preview list file before the image data is initially displayed for preview by the preview output device and reconstructs the preview list file such that contents in the preview list file matches contents in the image data.

7. A preview image output system comprising:
a determination device that determines if any of images of a plurality of frames representative of image data recorded on a recording medium has not been output for preview;
an input device that inputs a preview output command;
a reading device that, in response to an input of a preview output command from the input device, reads from the recording medium image data representing at least one image determined not to have been output for preview by the determination device; and
a preview output device that initially outputs for preview at least one image represented by the image data read out by the reading device.

8. A preview image output system according to claim 7, wherein the preview output device is a display apparatus that initially displays in a preview display region the image data read out by the reading device.

9. A preview image output system according to claim 7, wherein the preview output device is a printer that prints on a preview paper images represented by the image data read out by the reading device.

10. A preview image output system according to claim 7, wherein the recording medium records a preview list file that stores data indicative of images that have not been output for preview, and the determination device determines the image that has not been output based on the data stored in the preview list file.

11. A preview image output system according to claim 6, further comprising a reconstructing device that compares the image data with the data stored in the preview list file before the image data is initially displayed for preview by the preview output device and reconstructs the preview list file such that contents in the preview list file matches contents in the image data.

12. A method for controlling a preview image output system, the method comprising:
comparing image data representative of a plurality of images with a preview list file that records at least data indicating that images have been displayed for preview;
determining if any of the plurality of images in the image data have not been output for preview; and
outputting at least one image among the plurality of images in the image data that is determined not to have been output for preview.

13. A method for controlling a preview image output system according to claim 12, wherein the preview list file records at least data indicating that thumbnail images representing the images have been displayed for preview, and the outputting step includes the step of outputting at least one thumbnail image representing a corresponding one of the plurality of images in the image data.

14. A method for controlling a preview image output system according to claim 13, wherein the step of outputting at least one thumbnail image includes displaying in a preview display region.

15. A method for controlling a preview image output system according to claim 18, wherein the step of outputting at least one thumbnail image includes printing an image representing at least one thumbnail image.

16. A method for controlling a preview image output system according to claim 12, wherein the preview list file stores data indicative of images that have not been output for preview, and the determining step includes the step of determining the image that have not been output based on the data stored in the preview list file.

17. A method for controlling a preview image output system according to claim 12, further comprising the reconstructing step including comparing the image data with the data stored in the preview list file before the image data is initially displayed for preview and reconstructing the preview list file such that contents of the preview list file match contents of the image data.

18. A method for controlling a preview image output system, the method comprising:
determining if any of images of a plurality of frames representative of image data recorded on a recording medium have not been output for preview;
reading from the recording medium, in response to an input of a preview output command, image data representing at least one image determined not to have been output for preview by the determination device; and
outputting for preview at least one image represented by the image data read out for initial preview.

19. A program for controlling a computer of a preview image output system, the program implemented for:
determining if any of images of a plurality of frames representative of image data recorded on a recording medium have not been output for preview;
reading from the recording medium, in response to an input of a preview output command, image data representing at least one image determined not to have been output for preview by the determination device; and
outputting for preview at least one image represented by the image data read out for initial preview.

20. A recording medium that stores a program for controlling a computer of a preview image output system, the program implemented for:
determining if any of images of a plurality of frames representative of image data recorded on a recording medium have not been output for preview;
reading from the recording medium, in response to an input of a preview output command, image data representing at least one image determined not to have been output for preview by the determination device; and
outputting for preview at least one image represented by the image data read out for initial preview.
